(19) United States
(12) Patent Application Publication
(10) Pub. No.: US 2026/0188708 A1
(43) Pub. Date: Jul. 2, 2026

(54) THREE-DIMENSIONAL PLATE FOR A FUEL STACK, CORRESPONDING STACK, USE AND MANUFACTURING METHOD

(71) Applicant: HOPIUM, Paris (FR)

(72) Inventors: Fabien Guimard, La Motte Servolex (FR); Hadrien Dufour, Cognin (FR)

(21) Appl. No.: 18/877,528

(22) PCT Filed: Jun. 20, 2023
(86) PCT No.: PCT/EP2023/066704

§ 371 Date: Dec. 20, 2024

(30) Foreign Application Priority Data
Jun. 20, 2022 (FR) FR2206052

(51) Int. Cl. H01M 8/0254; B60L 50/70; B60R 16/03; H01M 8/0265; H01M 8/0267; H01M 8/10

(52) U.S. Cl. CPC H01M 8/0254; H01M 8/0265; H01M 8/0267; B60L 50/70; B60R 16/03; H01M 2008/1095; H01M 2250/20

(57) ABSTRACT

A bipolar or monopolar plate for a proton-exchange membrane fuel cell, each having first channels for circulation of reactive gases, dihydrogen and air respectively, and second channels for circulation of a heat-transfer fluid. The first and second channels extend in orthogonal directions along the length and the width, respectively, of the plate and follow a path defining undulations in an undulation plane substantially perpendicular to the main plane of the plate, and the channels have a cross-section varying between a maximum cross-section and a minimum cross-section, the minimum cross-section corresponding to the locations in which one of the first channels crosses one of the second channels.

### CROSS-REFERENCE TO RELATED APPLICATIONS

This Application is a Section 371 National Stage Application of International Application No. PCT/EP2023/066704, filed Jun. 20, 2023, and published as WO 2023/247580 A1 on Dec. 28, 2023, not in English, which claims priority to and the benefit of French Patent Application No. 2206052, filed Jun. 20, 2022, the contents of which are incorporated herein by reference in their entireties.

### 1. FIELD OF THE INVENTION

The field of the invention is that of hydrogen fuel stacks. More precisely, the invention relates to the improvement of such fuel stacks, and in particular of the bipolar and monopolar plates from which they are formed.

Such plates, and thus such stacks, have uses in numerous fields, as soon as it is necessary to produce electric energy, in particular independently, for example in vehicles (motor vehicles, utility vehicles, lorries, buses, trains, ships, aircraft, etc.), engine-generators, etc.

### 2. PRIOR ART

The principle of the fuel stack has been known for many years. It has been in particular implemented in the space field, and numerous projects have also been developed by various motor vehicle manufacturers.

A hydrogen fuel stack is based on the principle illustrated in FIG. 1, and produces electric energy via a chemical reaction between dihydrogen (H₂) and dioxygen (O₂). This chemical reaction is described by the equations below:

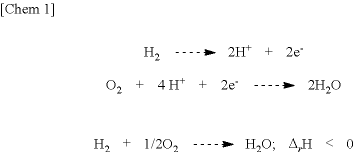

The optional term ΔᵣH<0 indicates merely that the reaction is exothermal.

This reaction occurs in what is called an active zone of an assembly of an electrolyte membrane and electrodes (MEA, for “Membrane Electrode Assembly”), that is to say a stack of membranes allowing the exchange of H⁺ ions, placed between an anode, receiving dihydrogen from a tank, and a cathode receiving dioxygen (O₂) from the outside air. As illustrated in FIG. 1, the fuel, the dihydrogen (H₂), is introduced (F1) into the stack, to come in contact with the anode A. A part of the dihydrogen penetrates (F2) into the anode A, in which the molecules of dihydrogen are separated into e electrons and H⁺ ions that pass through the electrolyte E towards the cathode C. The latter is in contact with the air brought from the outside (F3), the O₂ dioxygen molecules of which (F4) combine with the H⁺ ions and the e electrons to produce (F5) water (H₂O). This water (F6) and the air not used (F7) are evacuated.

The anode A is thus the element in which the oxidation occurs: H₂>2H⁺+2e⁻, and the cathode C is the element in which the reduction occurs: O₂+4H⁺+4e⁻>2H₂O. The e-electrons circulate (F8) between the anode A and the cathode C, producing an electrical current E, which is used to drive an electric motor and/or charge a battery.

This reaction is exothermal, and the various elements forming the stack can heat up rapidly.

The whole system must therefore be cooled. The design of the mechanical parts must therefore be adapted to be supplied with coolant, or heat transfer fluid.

The structure of a fuel stack, implementing this chemical reaction, is illustrated in FIG. 2. The stack 21 consists of a stack of cells 22, placed between two end plates 23₁ and 23₂.

The elements forming a cell 22 are described in detail, in an exploded view, in FIG. 3. It comprises two plates, bipolar or monopolar, between which an electrolyte membrane is placed. The monopolar plates are the first and the last plates of the stack of the cells. They generally have the same design as a bipolar plate, but inputs are closed so that the plate does not receive one of the gases. The stack thus comprises a cathode monopolar plate not receiving dihydrogen and an anode monopolar plate not receiving dioxygen.

The bipolar plates, stacked between two monopolar plates, consist of the assembly of two metal half-plates 31, 32 (an anode half-plate 31 and a cathode half-plate 32), which can be welded, brazed or glued. A space between the two metal half-plates is defined by the forming of the latter to define on the one hand zones 33, 34 receiving a coolant and on the other hand channels allowing the circulation of the gases, respectively dihydrogen and dioxygen (extracted from the air). Membranes MEA 35 are interposed between the half-plates.

One of the difficulties in the design of fuel stacks, and of these plates in particular, is the optimisation and the homogenisation of the trajectory of this coolant, which is generally imposed by that which was designed for the circulation of the gases of the anode and cathode parts.

Different types of channels for the circulation of the gases are known, in particular channels that are straight, parallel to each other, serpentine or in a zig-zag, extending over an active part of the plate.

The efficiency of these plates is not perfect. Despite the efforts of the designers, significant variations in the pressure of the gases, in particular of the oxygen, in the active surface, and a non-homogeneous distribution of the heat transfer fluid, in particular partial in the plate middle, are observed. This introduces a thermal inhomogeneity, in particular the presence of hot spots.

Consequently, this introduces an inhomogeneity in the creation of the electric current in the plate.

Such plates are furthermore not very easy to manufacture and to assemble. They have in particular poor rigidity over their length, which leads to using relatively thick, and thus heavy, metal strips, and imposes the use of manufacturing techniques not very adapted to production in series, such as brazing or multiple welds.

There is therefore a need for a novel approach for the manufacturing of such plates, to allow a production more adapted to the requirements of the series and/or to improve their efficiency.

### 3. MAIN FEATURES OF THE INVENTION

The invention meets at least a part of this need via a new type of bipolar or monopolar plate for a fuel stack with a proton-exchange membrane, each having first channels for circulation of reactive gases, dihydrogen and air respectively, and second channels for circulation of a heat-transfer fluid.

According to the invention, said first and said second channels extend according to orthogonal directions D1, D2, respectively according to the length and the width of said plate, and follow a path defining undulations in an undulation plane substantially perpendicular to the main plane of said plate, and said channels have a variable cross-section between a maximum cross-section (Sₘₐₓ) and a minimum cross-section (Sₘᵢₙ), said minimum cross-section (Sₘᵢₙ) corresponding to the locations at which one of said first channels crosses one of said second channels.

In other words, the plate, and in particular its active surface, that is to say the surface ensuring the exchange of protons, located facing the membrane, is defined in three dimensions, and not according to a plane. It has undulations, or “troughs” and “bumps”, determined so as to optimise the pressure of said gases and/or the flow rate of said heat transfer fluid.

Moreover, said channels extend in a direction orthogonal to the direction of said second channels, and parallel to the length and to the width of the respective plate, by crossing each other and by following the undulations.

Finally, the channels have a variable cross-section, so as to in particular optimise the pressure of said gases and/or the current density delivered by said plate.

This combination of crossing of the channels and of variable cross-sections allows to improve the efficiency of the plates, while optimising their rigidity and while limiting their thickness. According to a specific embodiment, said paths defining undulations and/or said variable cross-sections are defined by the finite element method, according to at least one criterion belonging to the following group:
optimisation of the fluid distribution in said channels;
optimisation of the rigidity of each plate;
limitation of the thickness of a cell of a fuel stack, formed by a first plate, a membrane and a second plate.

This approach allows to efficiently characterise the dimensions and shapes of the plates.

In particular, it is thus possible to industrially produce a fuel cell, formed by a first plate, a membrane and a second bipolar plate, smaller than 1 mm.

According to a specific embodiment, the plate is created by assembly of two complementary half-plates, formed in three dimensions, so as to define said undulations.

The half-plates can in particular be obtained by hydroforming.

According to a specific embodiment, said undulations have a radius R and a period P such that R=P±20%.

According to a specific embodiment, said cross-section varies so that the ratio between the maximum cross-section Sₘₐₓ and the minimum cross-section Sₘᵢₙ is between 1.2 and 2, approximately 1.6 for example.

According to a specific embodiment, said half-plates are made from metal strips thinner than those conventionally used, for example from 316L stainless steel with a double carbon coating, having a thickness of 0.075 mm.

The invention also relates to the fuel stacks comprising a stack of plates as described above. The invention also relates to the uses of such stacks, in particular for at least one of the uses belonging to the group comprising:
motor vehicles;
utility vehicles;
buses or lorries;
ships;
1 aircraft;
railway vehicles;
1 engine-generators;
etc.

The invention also relates to a method for manufacturing a bipolar or monopolar plate as described above, comprising in particular the following steps:
manufacturing of two complementary half-plates in which said first and said second channels extend according to orthogonal directions D1, D2, respectively according to the length and the width of said plate, and follow a path defining undulations in an undulation plane substantially perpendicular to the main plane of said plate, and said channels have a variable cross-section between a maximum cross-section (Sₘₐₓ) and a minimum cross-section (Sₘᵢₙ), said minimum cross-section (Sₘᵢₙ) corresponding to the locations at which one of said first channels crosses one of said second channels; assembly of said complementary half-plates, so that said first and/or said second channels follow a path defining undulations in an undulation plane substantially perpendicular to the main plane of said plate.

The manufacturing of the half-plates can in particular be carried out by hydroforming.

### 4. LIST OF THE DRAWINGS

Other features and advantages of the invention will be clearer upon reading the following description of an exemplary embodiment, given as a simple illustrative and non-limiting example, and the appended drawings among which:

FIG. 1, already described in the preamble, illustrates the general principle of a fuel stack;

FIG. 2, already described in the preamble, presents the structure of a fuel stack, comprising a stack of cells;

FIG. 3, already described in the preamble, presents the elements forming a cell of FIG. 2, in an exploded view;

FIG. 4 schematically illustrates the main elements of a bipolar plate of the cell of FIG. 3;

FIGS. 5A and 5B respectively illustrate the trajectory of the flow of gas (dihydrogen or air) and the trajectory of the heat transfer fluid, following the undulations (only a portion of the half-plate is shown);

FIG. 6 is another view of a portion of the half-plate, showing the undulations according to the two orthogonal directions defined by the channels;

FIG. 7 schematically illustrates an example of an undulation;

FIG. 8 illustrates the variation in the cross-section of a gas channel.

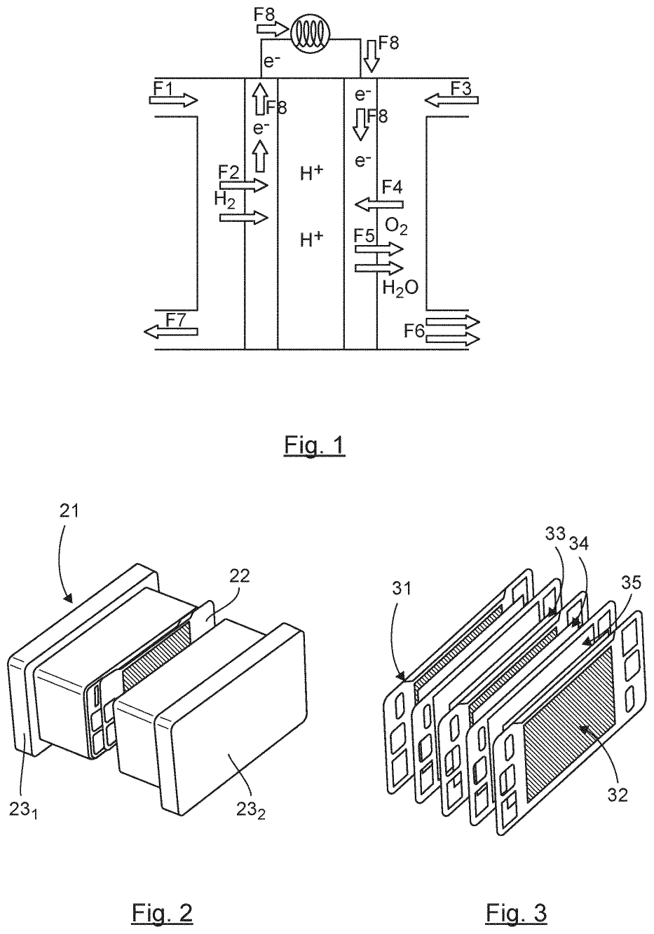

### 5. DESCRIPTION OF A SPECIFIC EMBODIMENT

### 5.1 Main Elements of a Bipolar Plate

The invention applies to the manufacturing of plates, bipolar or monopolar, intended to form a fuel stack.

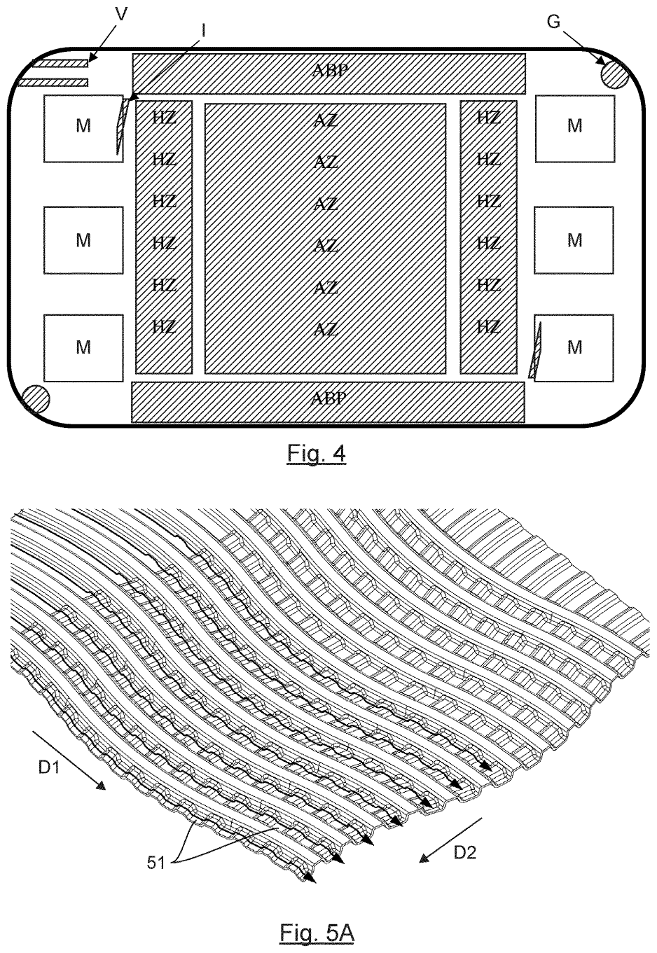

For illustrative purposes, the main aspects of a bipolar plate are described below. As schematically illustrated in the example of FIG. 4, there are several essential zones in a bipolar plate:
active zone AZ: this is the location in which the reaction takes place, consisting of numerous channels. One of the difficulties in the design of these plates is the necessity to provide a homogeneous distribution of the gas and not oversupply or undersupply the channels. The surface of the active zone of the plate is the same as that of the active zone of the MEA;
Homogenisation zone HZ: location in which the flows mix to supply the channels of the active zone with the same quantity of gas/coolant. It is comparable to a funnel, going from a flow inlet to the beginning of the active zone;
Anti-bypass zone ABP: an anti-bypass zone is necessary for mechanical reasons such as good maintaining of the MEA and/or good compression of the joint. It is then necessary to avoid an effect of bypass for the gases, which could induce drops in pressure of the gases, and thus reduce the efficiency of the entire system;
Manifolds M: the manifolds are elements acting on the dimensioning, comprising inlets and outlets for each gas and the refrigerant. Generally, their position and their dimensions define the overall dimensions of the plate;
Inlets I: the inlets are that which allows the gas and the refrigerant to go from the manifolds to the gas or refrigerant side of the plate;
Guide interfaces G: elements that help maintain the stack in position during the stacking process;
Measurement electrodes V: allowing to plug in a pin or a special device between the anode and the cathode to carry out measurements;
Data matrix: allowing a precise identification of the plate. It can in particular carry a serial number, an identification number of the supplier, a time, a manufacturing date, etc. Its dimensions are generally 4×4 or 5×5 mm;
Poka-yoke: mechanical element that constrains the positioning of the half-plates;
Welds: maintaining the half-plates together, they can be impermeable or simply intended to reinforce the structure.

### 5.2 Topology in Three Dimensions (3D)

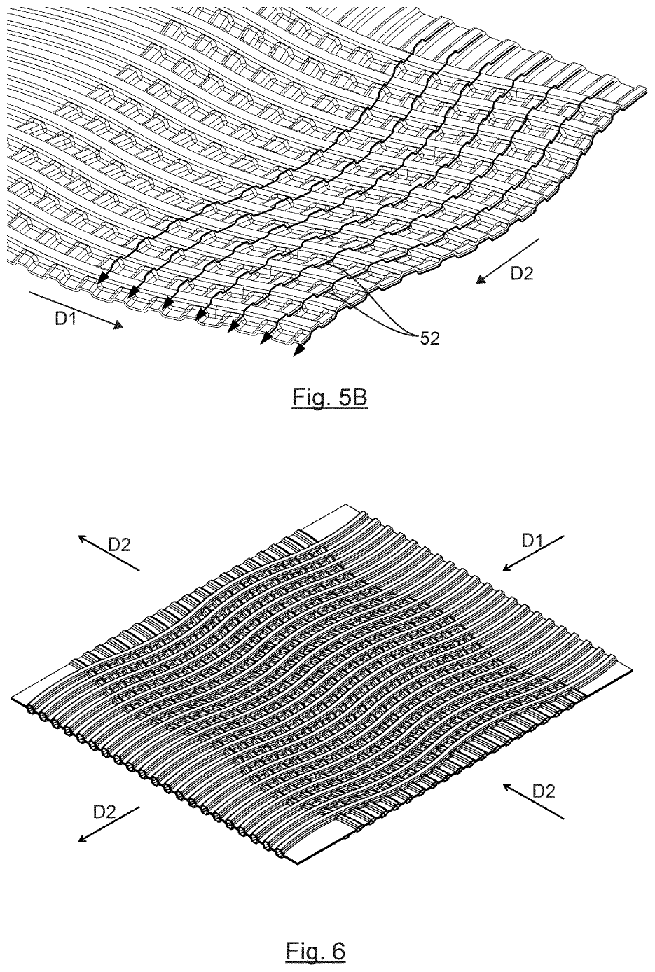

The invention thus proposes a novel approach to bipolar or monopolar plates, according to which the active zone of the latter, that is to say substantially the zone facing the membrane, allows the flows of gas and of heat transfer fluid to move in the three dimensions of space. More precisely, as illustrated by FIGS. 5A and 5B, respectively showing the trajectory of the flow of gas (dihydrogen or air) and the trajectory of the heat transfer fluid, the channels 51 intended for the gas and the channels 52 intended for the heat transfer fluid extend according to orthogonal directions D1, D2, respectively according to the length and the width of the plate, and cross each other. Moreover, these channels have undulations according to the two directions, the surface of the active part thus not being flat, but having “troughs” and “bumps”, as observed in particular in FIG. 6.

This approach has, with respect to the prior art according to which the channels extend in a plane, the planed defined by the plate, numerous advantages, according to the embodiments:
improvement of the thermal convection, allowing to reduce the flow rate and/or to improve the efficiency of the system;
better rigidity of the plate and/or gain in weight, making possible the reduction of the thickness of the metal strip;
improvement of the electric contact and reduction of the electric contact resistance;
facilitating the assembly of the stack, and in particular of the alignment of the cells with respect to each other, allowing in particular to avoid problems of sealing;
homogenisation of the oxygen partial pressure along the active surface;
homogenisation of the creation of current and improvement of the current density.

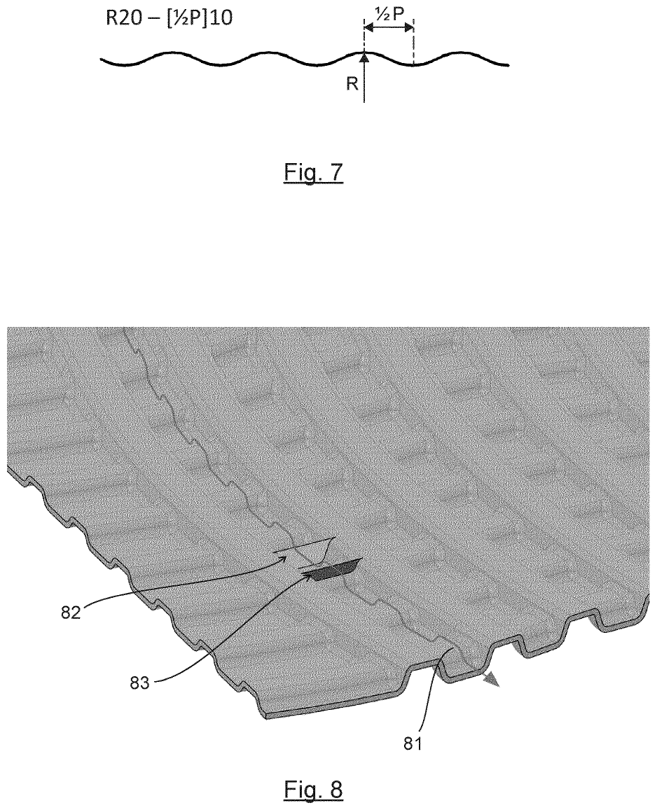

FIG. 7 schematically illustrates an example of undulations, characterised by its length, or period P and its radius R, or maximum height of the undulation. Of course, the shape of the undulation can be different from that illustrated.

The inventors determined, by taking into account in particular the constraints of tangency of the fluid channels, that a difference between the radius R and the half-period ½P less than or equal to 20% was efficient, so as to not make too strongly diverge the pair (radius; half-period) and obtain a balance between undulations that are too pronounced and undulations that are too fine. Identical or close values of ½P and of R are thus chosen, for example: R=P±20%. For informational purposes, the dimensions can be approximately:
½P: between 8 and 12 mm;
R: between 16 and 24 mm.

As illustrated in FIG. 7, it is possible for example to implement a radius R of 20 mm and a half-period of 10 mm.

The relative proportions of these geometric constraints allow a significant reduction in the thickness of the assembly of two metal strips, independently of the thickness of the material of the metal strip. The proportional links between the cross-sections of channels, their respective directions and the arrangement of the “bumps” allow, while ensuring a very good fluid distribution, to obtain a plate rigidity allowing an industrialisation and a conventional assembly, a very small fuel cell thickness (bipolar plate-membrane assembly-bipolar plate), which can be smaller than one mm.

It is important to note that the determination of these dimensions is not based on simple choices out of several possibilities, but is based on results of lengthy and non-obvious research, to meet several requirements of efficiency and industrialisation, much higher than the plates previously known.

More generally, the dimensions of the half-plate can be approximately:
length: between 250 and 350 mm;
width: between 150 and 200 mm.

The number of gas channels is for example between 50 and 100. The number of heat transfer fluid channels can also be between 50 and 100.

### 5.3 Channels Having Variable Cross-Section

According to another aspect of the invention, which can if necessary be implemented independently of the 3D topology described above, the cross-section of the channels is varied.

Indeed, the inventors have observed that the active zones according to the prior art, which have channels for the supply of the fluids having a constant cross-section, introduce heating and generate inhomogeneous partial pressures. Moreover, this has a negative effect on the rigidity of the plate.

To overcome these problems, there are in particular gas channels, the cross-section of which varies periodically, as illustrated by FIG. 8, in which it is observed that, along the trajectory 81 of the fluid, the cross-section of the channel varies between a maximum cross-section Sₘₐₓ 82 and a minimum cross-section Sₘᵢₙ 83.

This allows in particular to improve the rigidity of the plate, obtain better thermal convection, balance the partial pressures and/or obtain a better electric contact.

According to one embodiment, the maximum cross-section Sₘₐₓ corresponds to a location where the maximum height H of the gas channel and the minimum cross-section Sₘᵢₙ to a location where the gas channel crosses a heat transfer fluid channel (intersection, or “cross-channel”), the height being brought to the minimum height h.

The minimum cross-section corresponds to a location at which a first channel crosses an orthogonal second channel.

The ratio between H and h is preferably between 2 and 3, and for example such that H=2.5*h.

By simplification, it is considered that the width L of the channel, which varies little, is constant. Thus, the cross-section Sₘₐₓ equals approximately L*H, and the cross-section Sₘᵢₙ approximately (H−h)*L.

A ratio of variation of cross-section Sₘₐₓ/Sₘᵢₙ between 1.5 and 2, for example approximately 1.6, is thus preferably chosen.

It should be noted that this FIG. 8 illustrates a portion of a half-plate, and thus a half-cross-section of the channels that are obtained by the assembly of two half-plates, to form a complete plate. The ratios remain, however, obviously the same.

As an example for informational purposes, the dimensions can be approximately:
H: between 0.2 and 0.35 mm;
h: between 0.1 and 0.15 mm;
L: between 0.5 and 1.3 mm.

The paths defining the undulations and/or the variable cross-sections can in particular be defined by the finite element method, so as to maximise one or more criteria, and in particular:
optimisation of the fluid distribution in said channels;
optimisation of the rigidity of each plate;
limitation of the thickness of a cell of a fuel stack, formed by a first plate, a membrane and a second plate.

These paths can define a pattern of channels repeated several times.

### 5.4 Manufacturing and Assembly

The approach of the invention allows to manufacture half-plates from metal strips finer than those conventionally used, for example made of 316L stainless steel with a double carbon coating, having a thickness of 0.075 mm. Indeed, the forming in three dimensions allows to reinforce the rigidity (a conventional flat plate can have a tendency to be deformed), and thus to limit the possible defects in alignment. This allows to create stacks requiring less material, and thus less heavy and less costly.

Of course, the shape in three dimensions, the half-plates having undulations according to two orthogonal directions (corresponding to the directions of the channels) and/or the presence of channels having variable cross-sections require particular care during the production of the half-plates, for example by stamping or moulding. A preferred mode of manufacturing is hydroforming, which has numerous advantages, such as the precision in the repeatability of the process, the elasticity after forming, the homogeneity of the thickness of the wall, the efficiency of the contact zones, the adaptability, etc.

However, this shape and/or reduced thickness of the metal strips can allow a simpler and more reliable assembly of the two half-plates forming each plate, in particular for the rigid connection of the half-plates, for example by welding, and for the assembly of the plates to form a stack. The stacking of 300 plates, for example, to form a stack is thus simplified and more efficient, which allows in particular to reduce the risk of loss of sealing.

According to the prior art, it is necessary to carry out a homogenisation of the surface of the plate. However, this is not necessary according to the approach of the invention, which allows to obtain a homogeneous current, as much as possible, and thus to avoid the presence of hot spots, introducing risks of deterioration and contamination, without additional treatment. The invention thus allows to obtain very efficient plates and stacks, adapted to numerous uses, for example in motor vehicles, and more generally in any type of vehicle or means carrying fuel stacks.

The invention can moreover be used with membranes having different formats according to the stacks, so as to define several dimensions of active zones, and thus stacks having different power outputs from identical plates. This is in particular made possible by the homogeneity obtained via the approach of the invention.

Although the present disclosure has been described with reference to one or more examples, workers skilled in the art will recognize that changes may be made in form and detail without departing from the scope of the disclosure and/or the appended claims.

1. A bipolar or monopolar plate for a fuel stack with a proton-exchange membrane, the plate comprising:
first channels for circulation of reactive gases, dihydrogen and air respectively; and
second channels for circulation of a heat-transfer fluid,
wherein said first and said second channels extend according to orthogonal directions, respectively according to a length and a width of said plate, and follow a path defining undulations in an undulation plane substantially perpendicular to a main plane of said plate,
and wherein said first and second channels have a variable cross-section between a maximum cross-section and a minimum cross-section, said minimum cross-section corresponding to locations at which one of said first channels crosses one of said second channels.

2. The bipolar or monopolar plate according to claim 1, wherein said paths defining undulations and/or said variable cross-sections are defined by a finite element method, according to at least one criterion belonging to the following group:
optimisation of fluid distribution in said channels;
optimisation of rigidity of each plate;
limitation of a thickness of a cell of a fuel stack, formed by a first plate, a membrane and a second plate.

3. The bipolar or monopolar plate according to claim 1, wherein the plate comprises an assembly of two complementary half-plates, formed in three dimensions, so as to define said undulations.

4. The bipolar or monopolar plate according to claim 1, wherein said undulations have a radius (R) and a period (P) such that R=P±20%.

5. The bipolar or monopolar plate according to claim 1, wherein said cross-section varies so that the ratio between the maximum cross-section and the minimum cross-section is approximately 1.6.

6. A fuel stack comprising:
a first bipolar or monopolar plate according to claim 1;
a membrane; and
a second bipolar or monopolar plate according to claim 1,
said fuel stack having a thickness smaller than 1 mm.

7. A fuel stack comprising a stack of plates, each plate according to claim 1.

8. A method comprising:
providing a fuel stack comprising a stack of plates and a proton exchange membrane, each plate being a bipolar or monopolar plate comprising:
first channels for circulation of reactive gases, dihydrogen and air respectively; and
second channels for circulation of a heat-transfer fluid,
wherein said first and said second channels extend according to orthogonal directions, respectively according to a length and a width of said plate, and follow a path defining undulations in an undulation plane substantially perpendicular to a main plane of said plate, and
wherein said first and second channels have a variable cross-section between a maximum cross-section and a minimum cross-section, said minimum cross-section corresponding to locations at which one of said first channels crosses one of said second channels; and
using the fuel stack in:
a motor vehicle;
a utility vehicle;
a bus or lorry;
a ship;
an aircraft;
a railway vehicle; or
an engine generator.

9. A method for manufacturing a bipolar or monopolar plate for a fuel stack with a proton-exchange membrane, the plate having first channels for circulation of reactive gases, dihydrogen and air respectively, and second channels for circulation of a heat-transfer fluid, wherein the method comprises:
manufacturing two complementary half-plates in which said first and said second channels extend according to orthogonal directions, respectively according to a length and a width of said plate, and follow a path defining undulations in an undulation plane substantially perpendicular to a main plane of said plate, and said channels having a variable cross-section between a maximum cross-section and a minimum cross-section, said minimum cross-section corresponding to locations at which one of said first channels crosses one of said second channels; and
assembling said complementary half-plates, so that said first and/or said second channels follow a path defining undulations in an undulation plane substantially perpendicular to the main plane of said plate.
